(19) United States
(12) Patent Application Publication
(10) Pub. No.: US 2011/0068917 A1
(43) Pub. Date: Mar. 24, 2011

(54) Emergency Notification Apparatus

(76) Inventors: Rudolph Puana, Kamuela, HI (US); Lynn Puana, Kamuela, HI (US)

(21) Appl. No.: 12/564,792

(22) Filed: Sep. 22, 2009

(51) Int. Cl. G08B 21/00; G08B 23/00; H04M 11/04

(52) U.S. Cl. 340/540; 340/286.01; 340/693.5; 379/45

(57) ABSTRACT

An emergency notification system includes a single-motion user input device and a processor in data communication therewith. The system includes an input jack for connecting the processor to a communication network for allowing communication between the processor and an emergency response entity. A microphone and a speaker are in data communication with the processor. The processor includes programming for causing the processor to actuate the microphone and the speaker to allow audio communication between a user and the emergency response entity through the communication network upon activation of the single-motion user input device.

### BACKGROUND OF THE INVENTION

This application relates to notification systems and, more particularly, to an emergency notification apparatus that enables a user to contact an emergency network by pressing a single button.

If and when an emergency event is experienced—whether a medical emergency, fire, or criminal act—a person desires to contact police, ambulance, or other appropriate authority for assistance as soon as possible. In fact, contacting such assistance very quickly may be the difference between life and death. In some cases, unfortunately, locating and then dialing a telephone may not always be convenient or feasible. Even with the popularity of cell phones, they are often times not carried by a person inside their own home or even at work.

Various devices have been proposed for making fast contact with an emergency network. Although assumably effective for their intended purposes, some of the proposed devices have attempted to incorporate emergency notification devices into other electronic devices in ways that would not be convenient or feasible to manufacture or use.

Therefore, it would be desirable to have an emergency notification system having a button that is separate from a telephone and which automatically makes an emergency 911 call when pressed. Further, it would be desirable to have an emergency notification system that may be positioned at multiple locations within a residence such that emergency assistance may be obtained quickly from many locations. In addition, it would be desirable to have an emergency notification system that may be individually programmed with specific information that may then be transmitted to the emergency notification network when the button is activated, such as address or medical information.

### SUMMARY OF THE INVENTION

Accordingly, an emergency notification system includes a single-motion user input device and a processor in data communication therewith. The system includes an input jack for connecting the processor to a communication network for allowing communication between the processor and an emergency response entity. A microphone and a speaker are in data communication with the processor. The processor includes programming for causing the processor to actuate the microphone and the speaker to allow audio communication between a user and the emergency response entity through the communication network upon activation of the single-motion user input device.

Therefore, a general object of this invention is to provide an emergency notification system that enables a user to communicate with an emergency network with a one-touch motion.

Another object of this invention is to provide an emergency notification system, as aforesaid, that allows multiple notification buttons to be positioned throughout a residence or commercial structure.

Still another object of this invention is to provide an emergency notification system, as aforesaid, that may optionally provide predetermined data to be transmitted to the notification network so that the user may be located more quickly, accurately, or with enhanced support.

Yet another object of this invention is to provide an emergency notification system, as aforesaid, in which the one-touch input is protected from inadvertent activation.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of an emergency notification system according to one embodiment of the present invention covering a telephone jack faceplate;

FIG. 2 is a perspective view of the emergency notification system as in FIG. 1 removed from the telephone jack faceplate;

FIG. 3 is a perspective view of the emergency notification system as in FIG. 2 from a reverse angle;

FIG. 4 is a perspective view of an emergency notification system according to another embodiment of the present invention with a cover in a closed configuration;

FIG. 5 is a perspective view of the emergency notification system as in FIG. 4 with the cover in an open configuration;

FIG. 6 is a perspective view of a data input device according to the emergency notification system

FIG. 7 is a block diagram of the emergency notification system as in FIG. 4.

### DESCRIPTION OF THE PREFERRED EMBODIMENT

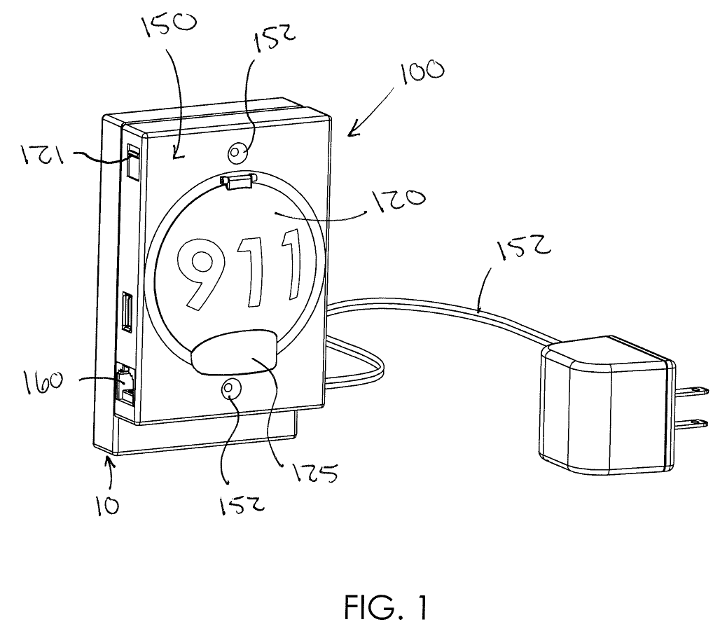

An emergency notification apparatus according to the present invention will now be described in detail with reference to FIGS. 1 through 7 of the accompanying drawings. More particularly, an emergency notification apparatus 100 according to one embodiment (FIGS. 1 through 3 and FIG. 7) includes a user input device 120 in data communication with a processor 110.

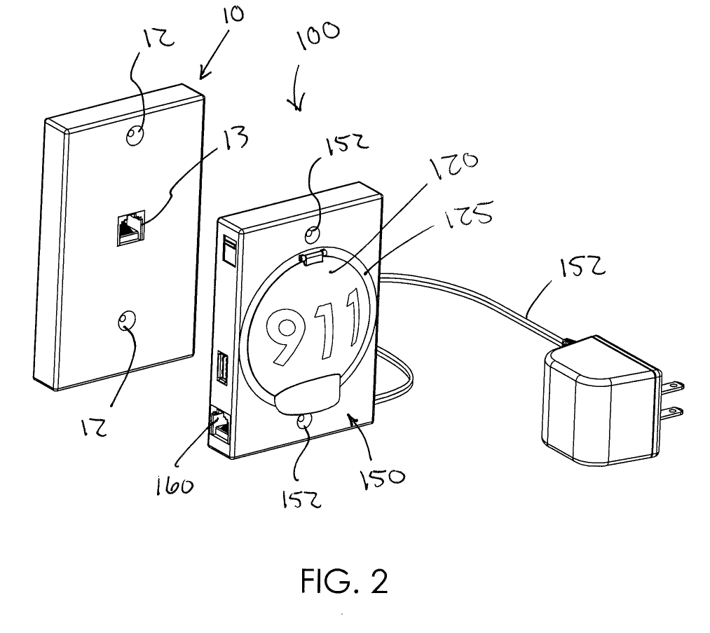

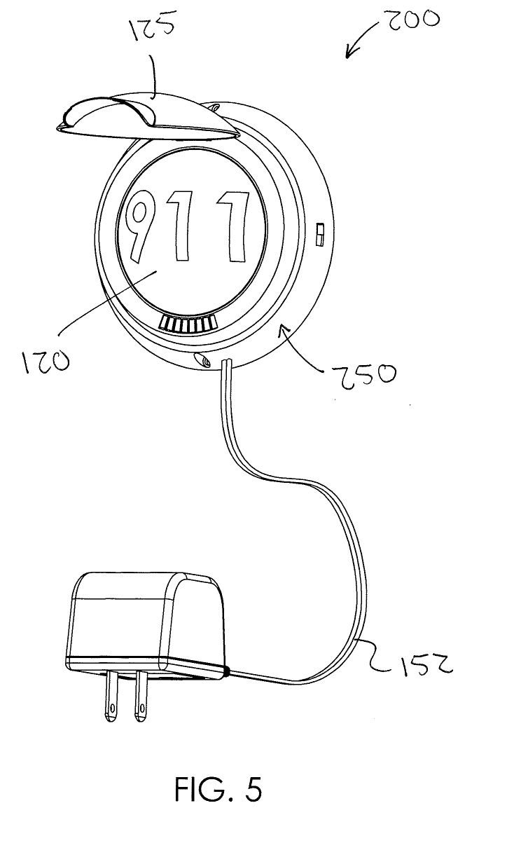

As shown in FIGS. 1 and 2, the input device 120 may be an input device that requires only a single motion (referred to herein as a “single-motion” input device), such as (for example) a button (shown in the accompanying drawings), switch, or knob. The input device 120 may further be lighted (e.g., by a LED or any other appropriate light source) and may have multiple settings of light intensity. Light intensity may be changed, for example, through switch 121, and the light may serve as a night light and also ensure that the input device 120 may be located. A cover 125 may cover the input device 120 to protect against unwanted activation, and the cover 125 may be movable and/or breakable to allow access to the input device 120. FIGS. 1 and 2 show the cover 125 in a position restricting access to the input device 120, and FIG. 5 shows the cover 125 pivoted to provide access to the input device 120.

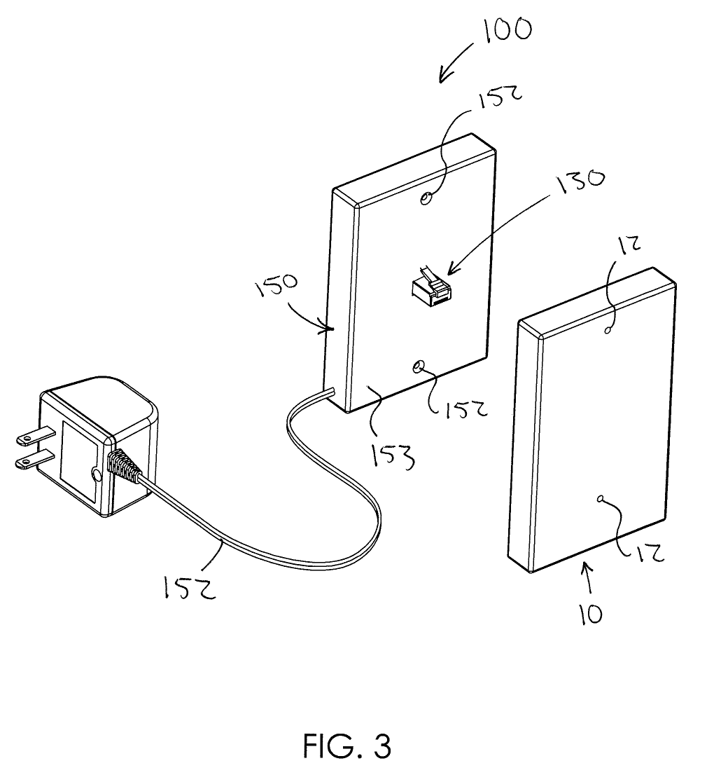

Means are included for connecting the processor 110 to a communication network (e.g., a telephone network) for allowing communication between the processor 110 and an emergency response entity (e.g., a 911 dispatch station). For example, an input jack 130 (FIG. 3) in data communication with the processor 110 may be included for connecting to the telephone network.

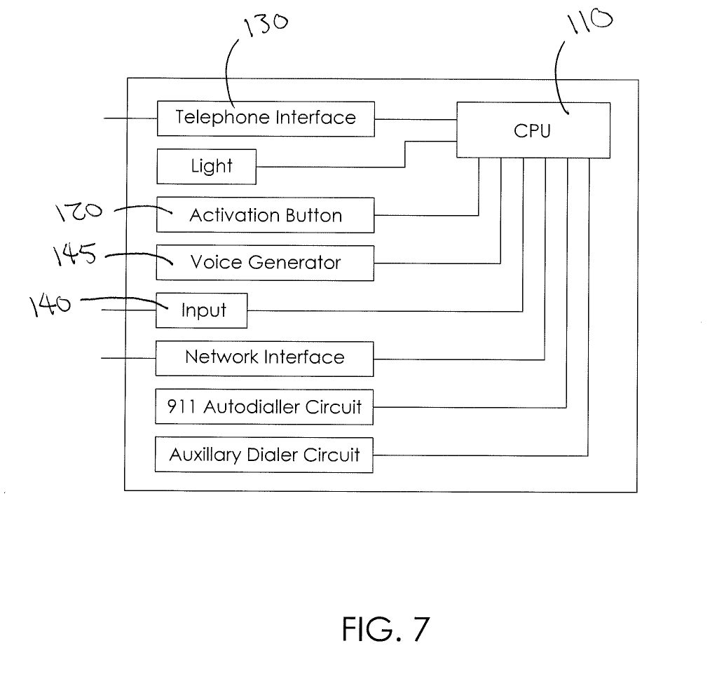

A microphone 140 and a speaker 145 are also in data communication with the processor 110, and the user input 120, the microphone 140, and the speaker 145 may be coupled to a housing 150. The processor 110 may be housed in the housing 150, and is accordingly only shown in FIG. 7. At least one power supply (e.g., electricity transferred through cord 152 or a battery) energizes the processor 110 and the other electrical components of the apparatus 100 that require electricity. Programming is included to cause the processor 110 to actuate the microphone 140 and the speaker 145 to allow audio communication between a user and the emergency response entity through the communication network after the input device 120 is activated.

As shown in FIGS. 1 through 3, the housing 150 may be configured to substantially cover a telephone jack faceplate 10. The housing 150 may have a plurality of screwholes 152 corresponding to screwholes 12 of the faceplate 10 such that screws (not shown) may pass through the housing screwholes 152 and the faceplate screwholes 12 to couple the housing 150 and the faceplate 10 to a support (e.g., a wall). A rear surface 153 of the housing 150 may be generally planar (FIG. 3) for abutment against the faceplate 10, and the input jack 130 may extend generally perpendicularly outward from the housing rear surface 152 (FIG. 3). As such, the input jack 130 may engage an output jack 13 (FIG. 2) when the housing 150 is coupled to the faceplate 10. A perimeter of the housing 150 (i.e., of the rear surface 152) may be bounded by a perimeter of the faceplate 10, as shown in FIG. 1, and in some embodiments the two perimeters generally correspond to one another.

An output jack 160 may be included (e.g., coupled to the housing 150, as shown in FIG. 1) to allow a telephone to be coupled to the telephone network through the input jack 130 and the output jack 160.

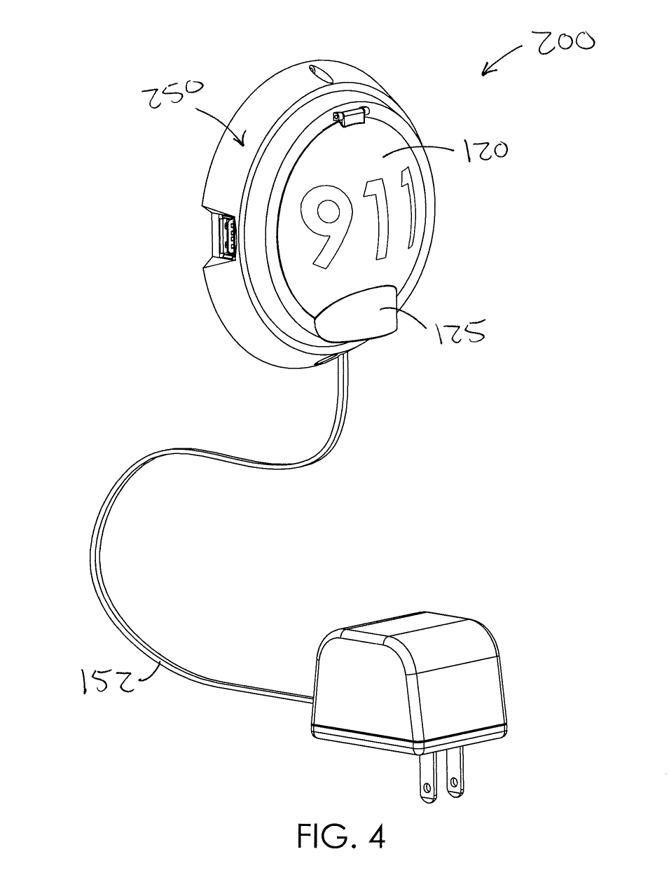

In use, the housing 150 is coupled to the faceplate 10 with the input jack 130 engaging the output jack 13. A telephone may be connected to the telephone network through the output jack 160 and used in a traditional manner. When assistance is needed, a user may activate the input device 120, which may require moving or breaking the cover 125. The processor 110 then actuates the microphone 140 and the speaker 145 to allow audio communication between the user and the emergency response entity through the communication network and causes a connection between the processor 110 and the emergency response entity to be made. The user may then communicate with the emergency response entity using the microphone 140 and the speaker 145. Another embodiment 200 of the emergency notification apparatus is shown in FIGS. 4 and 5. Embodiment 200 is substantially similar to embodiment 110 except as set forth herein and/or shown in the drawings, and the reference numbers set forth above are used to denote like parts. In embodiment 200, the housing 250 is not configured like housing 150. Instead, the housing 250 is configured to be located away from the faceplate 10, and the input jack 130 (not shown in FIGS. 4 and 5) is in communication with the processor 110 through a wired connection and/or a wireless connection. It should be appreciated that the location of various components may be altered in a similar manner so long as the necessary data communication is present.

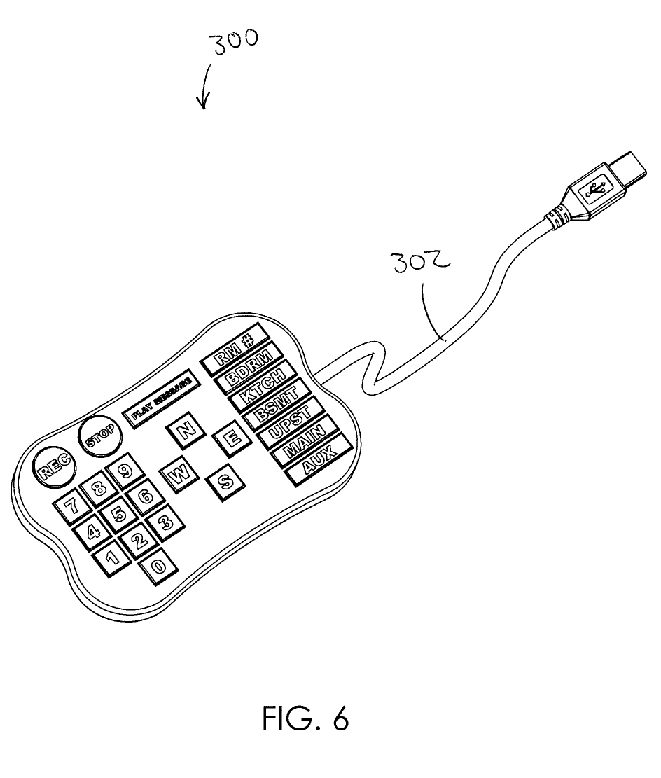

In some embodiments, a data storage device (e.g., inside the housing 150, 250) may be in data communication with the processor 110, and means for inputting preset data (e.g., a specific location within a property, a medical condition, etc.) to the data storage device may be included. The means for inputting may include a data input device 300 (FIG. 6) in selective communication with the data storage device (e.g., through cord 302 if the data input device 300 is separate from the housing 150, 250, as shown). The data input device 300 may have a plurality of prerecorded selections that may be selectively transmitted to the data storage device upon user selection, and the data storage device may store the chosen selections as the preset data. The data input device 300 may also (or alternately) have instructions for selectively inputting audio data from the microphone 140 or another microphone to the data storage device for storage as the preset data. Moreover, the data input device 300 may include instructions for selectively reviewing the preset data in the storage device using the speaker 145 or another speaker, and for selectively deleting the preset data from the data storage device. By using a data input device 300 that is separate from the housing 150, 250, a single data input device 300 may be used with multiple emergency notification apparatus. In addition, this may safeguard against the preset data being unintentionally or undesirably altered.

In embodiments with the data storage device, programming may cause the processor 110 to send a notification to the emergency response entity through the communication network upon activation of the input device 120, and the notification may include the preset data. Further, programming may cause the processor 110 to actuate the microphone 140 and the speaker 145 to allow audio communication between the user and the emergency response entity through the communication network after the notification is sent.

In embodiments such as these, then, the user may save a room's location or a health condition (e.g., diabetes, blindness, etc.), and this information would be transmitted upon activation of the input device 120 to further aid the emergency response entity in locating the emergency and providing adequate support and services.

It is understood that while certain forms of this invention have been illustrated and described, it is not limited thereto except insofar as such limitations are included in the following claims and allowable functional equivalents thereof.

1. An emergency notification apparatus, comprising:
a single-motion user input device;
a processor in data communication with said single-motion user input device;
means for connecting said processor to a communication network for allowing communication between said processor and an emergency response entity;
a microphone in data communication with said processor;
a speaker in data communication with said processor; and
programming causing said processor to actuate said microphone and said speaker to allow audio communication between a user and said emergency response entity through said communication network upon activation of said single-motion user input device.

2. The emergency notification apparatus of claim 1, wherein said single-motion user input device is a lighted button.

3. The emergency notification apparatus of claim 2, wherein:
said lighted button, said microphone, and said speaker are coupled to a housing; and
said processor is housed in said housing.

4. The emergency notification apparatus of claim 3, wherein said communication network is a telephone network; and wherein said means for connecting said processor to a communication network includes an input jack for connection to said telephone network, said processor being in data communication with said input jack.

5. The emergency notification apparatus of claim 4, further comprising an output jack to allow a telephone to be coupled to said telephone network through said input jack and said output jack.

6. The emergency notification apparatus of claim 5, wherein:
said housing is configured to substantially cover a telephone jack faceplate;
said housing has a plurality of screwholes corresponding to screwholes of said telephone jack faceplate such that screws may pass through said housing screwholes and said faceplate screwholes to couple said housing and said faceplate to a support;
said housing has a generally planar rear surface for abutment against said faceplate; and
said input jack extends generally perpendicularly outward from said housing rear surface.

7. The emergency notification apparatus of claim 6, wherein said faceplate has a perimeter, said housing rear surface has a perimeter, and said housing rear surface perimeter is substantially bounded by said faceplate perimeter.

8. The emergency notification apparatus of claim 7, further comprising a cover over said single-motion user input device, said cover being movable or breakable to access said single-motion input device.

9. The emergency notification apparatus of claim 8, wherein said emergency response entity is a 911 dispatch station.

10. The emergency notification apparatus of claim 9, wherein said lighted button has multiple settings of light intensity.

11. The emergency notification apparatus of claim 1, wherein said communication network is a telephone network; and wherein said means for connecting said processor to a communication network includes an input jack for connection to said telephone network, said processor being in data communication with said input jack.

12. The emergency notification apparatus of claim 11, further comprising an output jack to allow a telephone to be coupled to said telephone network through said input jack and said output jack.

13. The emergency notification apparatus of claim 11, wherein:
said single-motion user input device, said microphone, and said speaker are coupled to a housing; and
said housing is configured to substantially cover a telephone jack faceplate.

14. The emergency notification apparatus of claim 13, wherein:
said housing has a plurality of screwholes corresponding to screwholes of said telephone jack faceplate such that screws may pass through said housing screwholes and said faceplate screwholes to couple said housing and said faceplate to a support;
said housing has a generally planar rear surface for abutment against said faceplate; and
said input jack extends generally perpendicularly outward from said housing rear surface.

15. The emergency notification apparatus of claim 14, further comprising an output jack to allow a telephone to be coupled to said telephone network through said input jack and said output jack.

16. The emergency notification apparatus of claim 15, wherein said faceplate has a perimeter, said housing rear surface has a perimeter, and said housing rear surface perimeter is substantially bounded by said faceplate perimeter.

17. The emergency notification apparatus of claim 16, further comprising a cover over said single-motion user input device, said cover being movable or breakable to access said single-motion input device.

18. An emergency notification apparatus, comprising:
a user input device;
a processor in data communication with said user input device;
an input jack in data communication with said processor for connecting said processor to a telephone network for allowing communication between said processor and an emergency response entity;
a microphone in data communication with said processor;
a speaker in data communication with said processor; and
programming causing said processor to actuate said microphone and said speaker to allow audio communication between a user and said emergency response entity through said telephone network upon activation of said user input device.

19. The emergency notification apparatus of claim 18, further comprising an output jack to allow a telephone to be coupled to said telephone network through said input jack and said output jack; and wherein:
said user input device, said microphone, said speaker, said input jack, and said output jack are coupled to a housing;
said housing is configured to substantially cover a telephone jack faceplate;
said housing has a plurality of screwholes corresponding to screwholes of said telephone jack faceplate such that screws may pass through said housing screwholes and said faceplate screwholes to couple said housing and said faceplate to a support;
said housing has a generally planar rear surface for abutment against said faceplate; and
said input jack extends generally perpendicularly outward from said housing rear surface.
